(19) United States
(12) Patent Application Publication
(10) Pub. No.: US 2007/0038165 A1
(43) Pub. Date: Feb. 15, 2007

(54) Vibrational therapy assembly for treating and preventing the onset of deep venous thrombosis

(75) Inventors: Titi Trandafir, S. Plainfield, NJ (US); Roger J. Talish, Hillsborough, NJ (US); Kenneth McLeod, Vestal, NY (US)

Correspondence Address: CARTER, DELUCA, FARRELL & SCHMIDT, LLP, 445 BROAD HOLLOW ROAD, SUITE 225, MELVILLE, NY, 11747, US

(73) Assignee: Juvent Inc., Somerset, NJ (US)

(21) Appl. No.: 11/488,227

(22) Filed: Jul. 18, 2006

Related U.S. Application Data
(63) Continuation-in-part of application No. 11/369,467, filed on Mar. 7, 2006.
(63) Continuation-in-part of application No. 11/369,611, filed on Mar. 6, 2006.
(63) Continuation-in-part of application No. 11/388,266, filed on Mar. 24, 2006.
(60) Provisional application No. 60/700,092, filed on Jul. 18, 2005.
(60) Provisional application No. 60/702,735, filed on Jul. 27, 2005.
(60) Provisional application No. 60/702,815, filed on Jul. 27, 2005.
(60) Provisional application No. 60/659,216, filed on Mar. 7, 2005.
(60) Provisional application No. 60/659,159, filed on Mar. 7, 2005.
(60) Provisional application No. 60/665,013, filed on Mar. 24, 2005.

(51) Int. Cl. A61H 1/00

(52) U.S. Cl. 601/51; 601/61

(57) ABSTRACT

A vibrational therapy assembly treating and preventing Deep Venous Thrombosis, and other conditions, using vibrational energy.

### PRIORITY

The present application claims priority to a U.S. Provisional Application filed on Jul. 18, 2005 and assigned U.S. Provisional Application Ser. No. 60/700,092; the entire contents of the provisional application are incorporated herein by reference.

The present application further claims the benefit of and priority to U.S. Provisional Application filed on Jul. 11, 2006 titled “System and Method for a Low Profile Vibrating Plate”, the entire contents of the provisional application are incorporated herein by reference.

The present application is also a Continuation-In-Part patent application of a U.S. patent application filed on Mar. 7, 2006 titled “System and Method for a Low Profile Vibrating Plate” and assigned U.S. patent application Ser. No. 11/369,467; the entire contents of which are incorporated herein by reference. U.S. patent application Ser. No. 11/369,467 claims priority from U.S. Provisional Application filed on Mar. 7, 2005, titled “System and Method for a Low Profile Vibrating Plate” and assigned U.S. Provisional Application Ser. No. 60/659,216; the entire contents of which are incorporated herein by reference.

The present application is also a Continuation-In-Part patent application of U.S. patent application filed on Jul. 17, 2006 titled “Dynamic Motion Therapy Apparatus Having a Treatment Feedback Indicator”, the entire contents of which are incorporated herein by reference. U.S. patent application filed on Jul. 17, 2006, titled “Dynamic Motion Therapy Apparatus Having a Treatment Feedback Indicator” claims priority from U.S. patent application filed on Mar. 6, 2006 titled “supplemental Support Structures Adapted to Receive a Non-invasive Dynamic Motion Therapy Device” and assigned U.S. patent application Ser. No. 11/369,611; the contents of which are hereby incorporated by reference. U.S. patent application Ser. No. 11/369,611 claims priority from a U.S. Provisional Application filed on Mar. 7, 2005 and assigned U.S. Provisional Application No. 60/659,159; the contents of which are hereby incorporated by reference.

The U.S. patent application filed on Jul. 17, 2006 is also a Continuation-In-Part patent application of a U.S. patent application filed on Mar. 24, 2006 titled “Apparatus and Method for Monitoring and Controlling the Transmissibility of Mechanical Vibration Energy During Dynamic Motion Therapy” and assigned U.S. patent application Ser. No. 11/388,286; the contents of which are hereby incorporated by reference. U.S. patent application Ser. No. 11/388,286 claims priority from a U.S. Provisional Application filed on Mar. 24, 2005 and assigned U.S. Provisional Application No. 60/665,013; the contents of which are hereby incorporated by reference.

The U.S. patent application filed on Jul. 17, 2006 further claims the benefit of and priority to U.S. Provisional Application filed on Jul. 27, 2005 titled “Method and Apparatus for Monitoring Patient Compliance During Dynamic Motion Therapy” and assigned U.S. Provisional Application Serial No. 60/702,815; the contents of which are hereby incorporated by reference. Additionally, the U.S. patent application filed on Jul. 17, 2006 claims the benefit of and priority to U.S. Provisional Application filed on Jul. 27, 2005 titled “Dynamic Motion Therapy Apparatus Having a Treatment Feedback Indicator” and assigned U.S. Provisional Application Ser. No. 60/702,735; the contents of which are hereby incorporated by reference.

### CROSS-REFERENCE TO RELATED PATENTS

The present application is also related to U.S. Pat. Nos. 6,234,975; 6,561,991; and 6,607,497, the entire contents of which are incorporated herein by reference.

### BACKGROUND

1. Technical Field

The present disclosure relates generally to a non-invasive medical treatment apparatus. More particularly, the present disclosure relates to a vibrational therapy apparatus for delivering vibrational therapy and treating and preventing the onset of deep venous thrombosis (DVT).

2. Description of the Prior Art

Deep venous thrombosis (DVT) is the occlusion of a deep vein by a blood clot, i.e., thrombus. DVT generally affects the leg veins, such as, for example, the femoral vein or the popliteal vein, and occurs when the blood clot either partially blocks or completely blocks the flow of blood in the vein. A major risk associated with DVT is the development of pulmonary embolism, which occurs when a blood clot breaks loose from the walls of a vein and travels to the lungs, blocking the pulmonary artery or one of its branches.

Although there are several medical factors, such as injury, immobility and clotting disorders, which cause DVT other non-medical factors are also often culprits. For example, prolonged periods of sitting or lying, such as, for example, during an airline flight and a prolonged hospital stay which includes a prolonged period of immobility.

Various treatments have been developed to alleviate the effects of DVT. For example, intermittent pneumatic compression machines are used to improve blood circulation and prevent the formation of thrombi in the limbs of the patient. These devices typically include a pair of compression garments or sleeves which wrap around the patient's limbs, generally the legs. Each sleeve has a plurality of separate inflatable chambers which are connected via conduits to a source of compressed fluid, typically air. The chambers are sequentially inflated to provide a compressive pulse to the limb, thereby increasing blood circulation and minimizing the formation of thrombi. The compressive pulses begin around the portion of the limb farthest from the heart and progress sequentially towards the heart. For example, for a three-chambered leg sleeve, the ankle chamber is inflated first followed by the calf chamber, and then the thigh chamber. Typical compression devices are described in U.S. Pat. Nos. 4,013,069 and 6,610,021. Other methods of treatment for treating DVT include surgical procedures as well as medications, such as, anticoagulants.

However, because a patient may be susceptible to DVT and its effects with little or no warning, the best method against DVT and its effects is preventing the onset of DVT. For example, early and regular ambulation, i.e. walking, is a treatment that is recognized and recommended. Walking enhances blood flow by activating the body's muscle pumps, increasing venous velocity and preventing stasis. Nonetheless, walking is not a viable option for many people, such as elderly and/or infirm individuals. Moreover, walking is not always possible or safe, such as in an aircraft experiencing turbulence. Thus there is a need for a blood flow enhancement apparatus and method for enhancing blood flow to prevent the onset of DVT.

### SUMMARY

It is an aspect of the present disclosure to provide a vibrational therapy apparatus that delivers vibrational energy and may be used for treating and preventing the onset of DVT. It is a further object of the present disclosure to provide a vibrational therapy apparatus having a low profile vibrating plate system similar to the low profile vibrating plate system described in U.S. Utility patent application Ser. No. 11/369,467 filed on Mar. 7, 2006, the entire contents of which are incorporated herein by reference.

In accordance with the present disclosure, a vibrational therapy apparatus is provided capable of delivering vibrational energy for treating and preventing the onset of DVT. Other uses are also envisioned, such as treating postural instability. The vibrational therapy apparatus includes at least one platform member including at least one vibrating plate assembly for providing vibrational energy and at least one positioner. The at least one positioner is operatively associated with the at least one platform member for guiding patient tissue adjacent the at least one vibrating plate assembly.

Vibrational plate assembly can provide vibrational energy in at least two configurations of the at least one positioner. In a first configuration, the at least one positioner is substantially perpendicular to the at least one platform member. In a second configuration, the at least one positioner is in juxtaposed relation to the at least one platform member. Positioner is movable between the first configuration and the second configuration. In a first configuration, patient tissue contacts the at least one vibrating plate assembly, and in a second configuration, patient tissue does not contact the at least one vibrating plate assembly.

Vibrational therapy apparatus further includes at least one pad, positioned on the at least one platform member. The at least one pad is configured to contact patient tissue. Pad may be formed of memory foam material and may contact at least a portion of the at least one positioner. Pad may be removable from the apparatus and may be disposable.

Vibrational therapy apparatus further includes a control panel for controlling the operation of the at least one vibrating plate assembly.

In yet another embodiment of the present disclosure, a vibrational therapy assembly is provided which includes a first vibrational therapy apparatus having a first platform member including at least one vibrating plate assembly for providing vibrational energy and a first positioner operatively associated with the first platform member for guiding patient tissue adjacent the first platform member and a second vibrational therapy apparatus having a second platform member including at least one vibrating plate assembly for providing vibrational energy and a second positioner operatively associated with the second platform member for guiding patient tissue adjacent the first platform member and a means for removably connecting the first and second vibrational therapy apparatus. The means for removably connecting engages and disengages the first vibrational therapy apparatus from the second vibrational therapy apparatus.

The first vibrational therapy apparatus and the second vibrational therapy apparatus of the vibrational therapy assembly provide vibrational energy in at least two configurations of the first positioner and the second positioner. In a first configuration, the first and second platform members are parallel with respect to each other and the first and second positioners are substantially perpendicular to the first and second platform member. In a second configuration, the first and second platform members are parallel and with respect to each other and the first positioner and the second positioner are respectively in juxtaposed relation to the first platform member and the second platform member.

### BRIEF DESCRIPTION OF THE DRAWINGS

The foregoing features of the present disclosure will become more readily apparent and will be better understood by referring to the following detailed description of preferred embodiments, which are described hereinbelow with reference to the drawings wherein:

FIG. 1 is a perspective view of a vibrational therapy assembly including two vibrational therapy apparatuses in a portable configuration in accordance with the present disclosure;

FIG. 1A is a perspective view of a vibrational therapy apparatus of FIG. 1 in an open configuration illustrating the internal components thereof in accordance with the present disclosure;

FIG. 2 is a perspective view of the two vibrational therapy apparatuses of FIG. 1, pivotally attached and in an open configuration, illustrating the internal components thereof in accordance with the present disclosure;

FIG. 3 is a schematic view of a vibrating plate incorporated in the apparatus in accordance with the present disclosure;

FIG. 4 is a perspective view of the vibrational therapy assembly of FIG. 1 illustrating a method for opening the assembly when in a portable configuration;

FIG. 5 is a perspective view illustrating a method for lifting the positioners of the vibrational therapy apparatus in accordance with the present disclosure;

FIG. 6 is a perspective view illustrating a method for disconnecting the two vibrational therapy apparatuses in accordance with the present disclosure;

FIG. 7 is a perspective view illustrating the separated vibrational therapy apparatuses of FIG. 6 provided on a bed for enabling vibrational treatment for enhancing blood flow in the legs to treat or prevent the onset of DVT in accordance with the present disclosure;

FIG. 8 is a perspective view illustrating two vibrational therapy apparatuses in a closed configuration, configured to deliver vibrational therapy to a patient standing on the apparatuses; and

FIG. 9 is a perspective view illustrating the vibrational therapy apparatus of FIG. 8 providing vibrational energy to a patient.

### DETAILED DESCRIPTION

It is known to use vibrational treatment to treat conditions, such as postural instability, osteoporosis, etc., as described in U.S. Pat. Nos. 6,234,975; 6,561,991; and 6,607,497, the entire contents of which are incorporated herein by reference. The present disclosure provides for a vibrational therapy assembly and apparatus for providing vibrational treatment for treating and preventing the onset of deep venous thrombosis (DVT).

Preferred embodiments of the presently disclosed vibrational therapy assembly and apparatus will now be described in detail with reference to the drawing figures in which like reference numerals identify identical or corresponding elements.

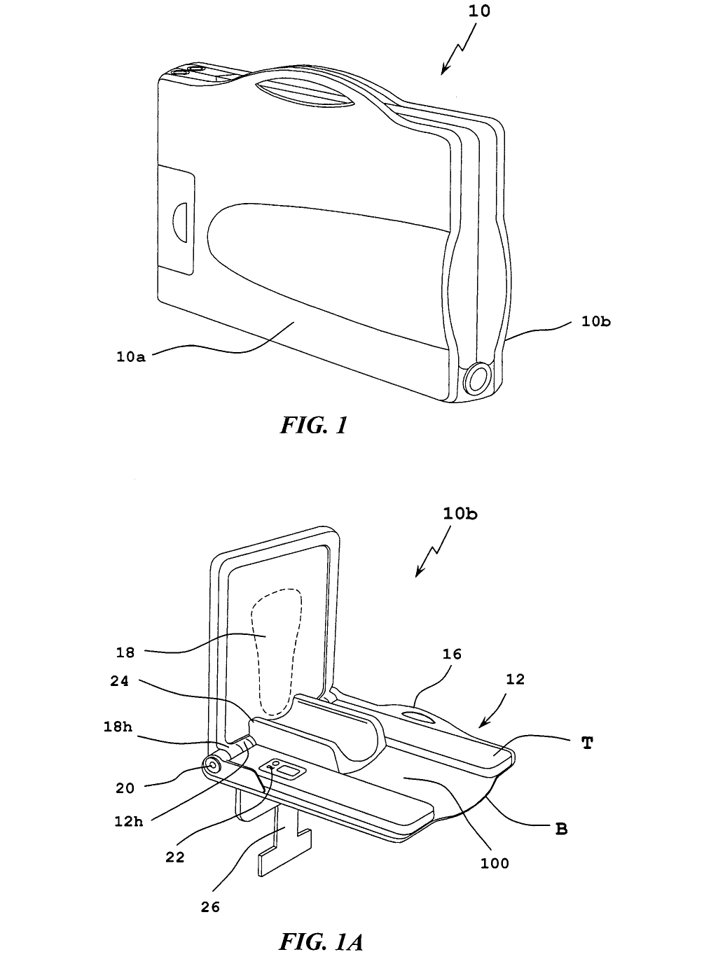

With initial reference to FIG. 1, a vibrational therapy assembly in accordance with the present disclosure is illustrated in a portable configuration, and is designated generally as vibrational therapy assembly 10. Vibrational therapy assembly 10 includes two vibrational therapy apparatuses 10a, 10b as described in the present disclosure. Vibrational therapy apparatuses 10a, 10b configured as a vibrational therapy assembly 10 is adapted to enhance blood flow and to treat and prevent the onset of DVT. However, one skilled in the art of vibrational treatment can envision conditions/ailments that can be treated or prevented using the assembly 10 and apparatus 10a, 10b.

FIG. 1A is a perspective view of vibrational therapy apparatus 10b, in an open configuration, illustrating the internal components thereof in accordance with the present disclosure. Apparatus 10b comprises platform member 12 and positioner 18. Platform member 12 includes a bottom portion B and top portion T. Platform member 12 includes at least one vibrating plate assembly 100, adapted to provide vibrational energy to patient tissue. The vibrational energy treats or prevents the onset of DVT.

Positioner 18 is operatively associated with platform member 12. In FIG. 1A, positioner 18 is hingedly attached to platform member 12. Pivot Pin 20 secures hinge portion 12h of platform member 12 to hinge portion 18h of positioner 18. Various other attachment means may be used such that positioner is pivotally attached to at least a portion of platform member 12 (i.e. a plurality of hinge sections, one or more living hinges, or more ball-joints, etc.).

Positioner 18 may guide positioning of patient tissue adjacent to at least a portion of platform member 12, such as, for example, guiding or positioning of a patient tissue adjacent the vibrating plate assembly 100. Patient tissue, such as, for example, a leg and/or foot, is oriented such that vibrational energy generated by the vibrating plate assembly 100 is transferred to patient tissue. Patient tissue may receive vibration energy by direct contact with vibrating plate assembly 100. Patient tissue may also receive vibrational energy indirectly from vibration plate assembly 100, wherein vibrational energy is transferred through another portion of assembly 10b. For example, patient tissue may contact the positioner 18 or the pad 24 and vibrational energy is transferred from the vibrating plate assembly 100 through the positioner or the pad and to patient tissue.

Positioner 18 may lock in one or more angular positions relative to platform member 12. Hinge section may include a locking mechanism for locking positioner 18 into one or more of the angular positions relative to platform member 12.

The angular positions of the positioner 18 relative to the platform member 12 may be determined by the clinician, the type of medical therapy delivered to patient or the orientation of the patient receiving the vibrational therapy. Positioner 18, as shown in FIG. 1 A, is positioned such that the angular relationship between the positioner 18 and the platform member 12 is substantially perpendicular and the platform member 12 is substantially horizontal.

In yet another embodiment of the present disclosure, pivoting mechanism may limit the angular movement of positioner 18, relative to the platform member 12, such that the angular condition of the positioner 18 in an open condition is optimal for a particular medical therapy. For example, for the treatment of DVT the pivoting mechanism may limit the angular movement of positioner 18, such that the maximum angular condition of the positioner 18 is substantially perpendicular to platform member 12.

Apparatus 10b may be repositioned or carried by grasping the handle 16 defined by the platform member 12.

Platform member 12 further includes at least one removable or fixed pad 24. Pad 24 supports the leg of a patient receiving vibrational treatment. The condition of pad 24 on platform member 12, relative to positioner 18, may be adjustable in order to provide proper support or positioning of the leg. Pad 24 may be placed against positioner 18 or spaced-apart from positioner 18.

Pad 24 may attach to platform member 12 to prevent movement during vibrational treatment. Various means of attachment may be used (i.e. velcro, snaps, buttons, clips, gel, adhesive or any combination thereof).

Apparatus 10b include at least one locating member 26 for locating the apparatus 10b during use. Locating member 26 may locate or position apparatus 10b relative to a structure, such as, for example, a bed, examination couch, patient stretch, patient trolley, patient recovery trolley, patient pallet, a chair, a wheelchair, an airline seat, a car seat, a bus seat, a sofa, a recliner, a scooter, etc.

Apparatus 10b may be positioned at the foot of a bed, or similar structure, with locating member 26 extending downward along the mattress at the foot of a bed thus preventing the apparatus 10b from moving toward the head of the bed during use. Similarly, locating member 26 may be positioned between the mattress and a bed's footboard thus securing the apparatus 10b to the foot of a bed.

Locating member 16 may position or secure apparatus 10b to a location approximate to a seat, such as a wheelchair, an airline seat, car seat, bus seat, recliner or scooter. For example, locating member 26 may be adapted to interface with a wheelchair footrest such that a patient sitting in a wheelchair may receive vibrational therapy. Locating member may be adapted to locate apparatus 10b in close proximity to patient's seat, such as a seat in an airplane, car or bus such that patient may receive vibrational therapy while traveling. Locating member 26 may be adapted to locate or position apparatus 10b relative to a sofa or recliner by extending into or under the sofa or recliner such that patient may receive vibrational therapy in the comfort of their home.

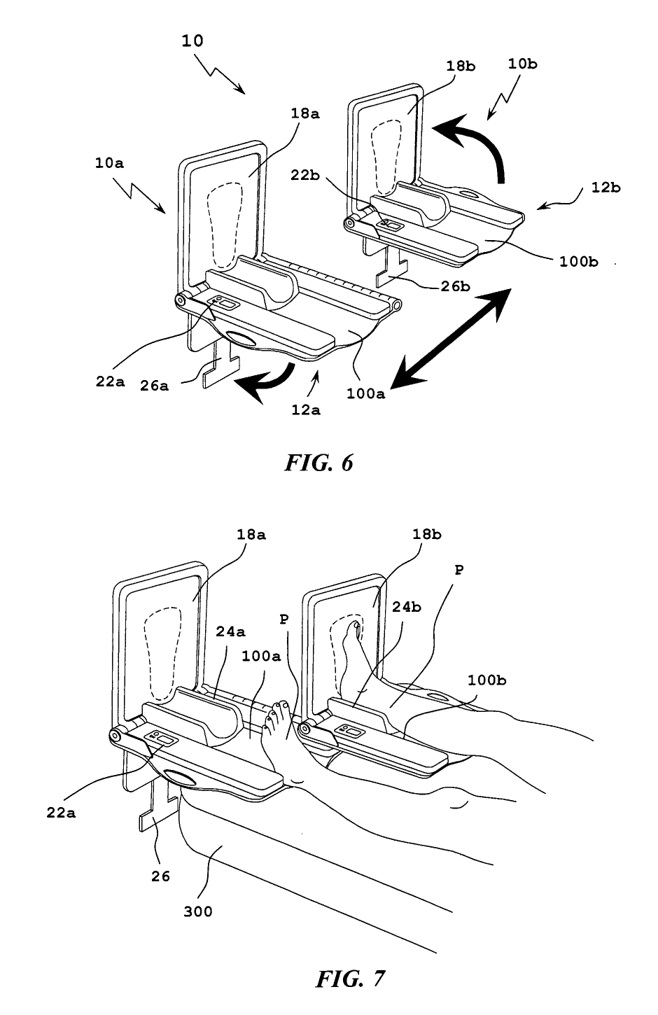

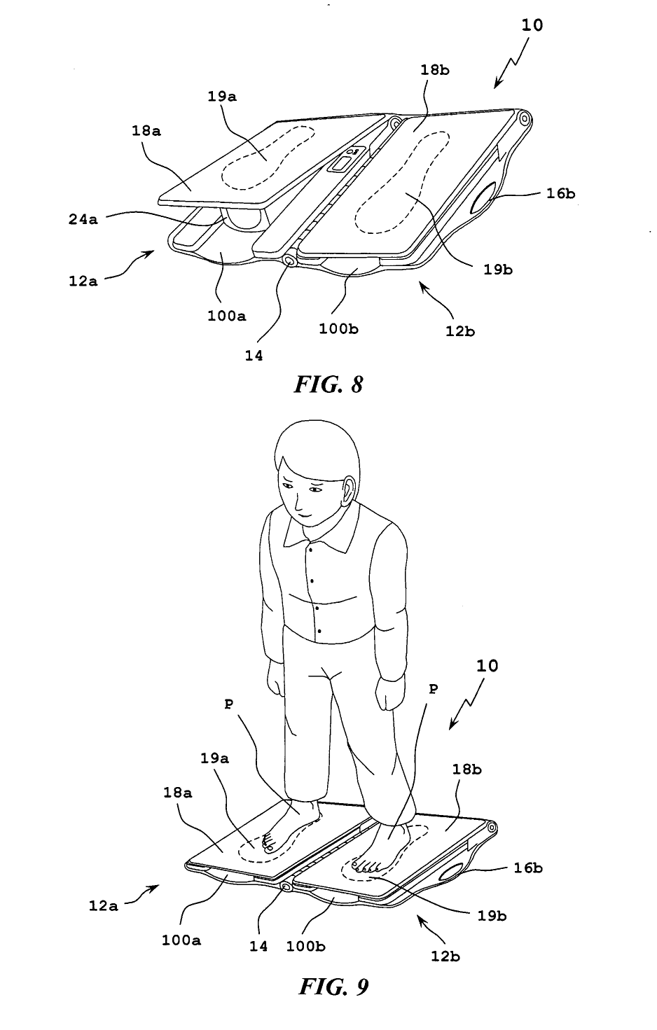

Locating member 26 may deploy from a first condition to a second condition. In the first condition, as illustrated in FIGS. 1 and 8, locating member 26 is substantially within or adjacent positioner 18 or platform member 12. In a second condition, as illustrated in FIGS. 1A and 6, at least a portion of locating member 26 is extended from positioner 18 or platform member 12. Locating member 26 may be pivotally attached to positioner 18 or platform member 12 wherein locating member 26 rotates about the pivot from the first condition to the second condition.

It is further envisioned to integrate the apparatus 10 with structure, such as to integrate the apparatus 10 with a bed, examination couch, patient stretch, patient trolley, patient recovery trolley, patient pallet, a chair, a wheelchair, an airline seat, a car seat, a bus seat, a sofa, a recliner, a scooter, etc.

Vibrational therapy apparatus 10b includes a low profile vibrating plate assembly 100 similar in structure and operation as the low profile vibrating plate system disclosed and described in U.S. Utility application Ser. No. 11/369,467 filed on Mar. 7, 2006 and in U.S. Provisional Application filed on Jul. 11, 2006.

Platform member 12 includes a low profile vibrating plate assembly 100 adapted for transmitting vibrational energy, as described in detail hereinbelow. Platform member 12 may further include a control panel 22 for controlling the operation of the vibrating plate assembly 100. Control panel 22 may include a user interface for programming the apparatus 10. Control panel 22 can be removed from platform member 12 and configured to operate as a remote control device in operative communication with vibrating plate assembly 100. Control panel 22, configured to operate as a remote control device, communicates via wired or wireless means with the apparatus 10b.

Apparatus 10b can also be provided with touch sensitive technology for sensing when the patient's foot is positioned to receive vibrational therapy. Vibrating plate assembly 100 is activated or actuated when it senses that the patient's foot is positioned to receive vibrational therapy, i.e. placed over the vibrating plate assembly 100 or in contact therewith or with pad 24.

Apparatus 10b is preferably powered by at least one battery for enabling the apparatus 10b to be mobile. Apparatus 10b may also include a power cord for plugging the apparatus 10b to an electrical outlet, when feasible, for charging or conserving battery power.

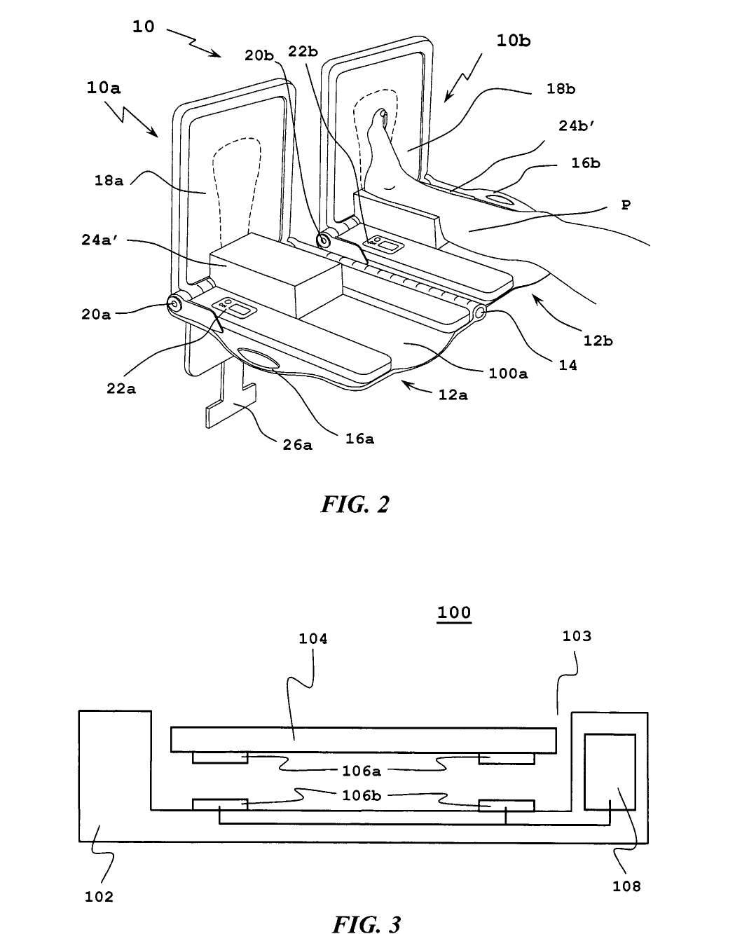

Referring now to FIG. 2, the vibrational therapy assembly 10 of FIG. 1 is illustrated with a first vibrational apparatus 10a and a second vibrational therapy apparatuses 10b. First vibrational apparatus 10a is operatively associated with second vibrational therapy apparatus 10b. Apparatuses 10a, 10b may be hingedly attached along one side with a connecting pin 14. First and second vibrational apparatuses 10a, 10b will disengage if connecting pin 14 is removed. Alternatively, the connecting means may include hinges, one or more ball and socket joints, one or more living hinges or other means of operatively associating two members as known in the art.

Each vibrational apparatus 10a, 10b include a platform member 12a, 12b and a positioner 18a, 18b operatively associated with each respective platform member 12a, 12b. Positioner 18a, 18b and the respective platform member 12a, 12b may be hingedly attached along one side with pivot pin 20a, 20b. Other means of forming a pivotal connection may be used, such as, for example, a plurality of hinges, one or more ball and socket joints, one or more living hinges or other means of operatively associating two members as known in the art.

Platform members 12a, 12b may define handles 16a, 16b, and include control pads 22a, 22b and at least one vibrating plate assembly 100a, 100b. Handles 16a, 16b are disposed at respective sides of platform members 12a, 12b which are advantageously configured to enable one to grasp and transport the apparatus 10 when in the portable configuration as illustrated in FIG. 1.

Locating members 26a (26b not shown) may be used to locate or position assembly 10 relative to a structure. Other configurations for the locating member 26a other than the configuration shown by the figures are envisioned. It is further envisioned to integrate the assembly 10 with structure, such as to integrate the assembly 10 with wheelchair, a bed, a chair, a scooter, patient pallet, examination couch, patient stretch, patient trolley, patient recovery trolley, etc.

Referring again to FIG. 1A, in use, pad 24 supports or positions a patient's leg for receiving vibrational treatment. Vibrational energy from vibrating plate assembly 100 is transferred to the patient's leg directly or through pad 24. Pad 24 may be formed of one or more materials with at least one material adapted to transfers energy from the vibrating plate assembly 100 to the patient. Pad 24 may be formed from various materials, such as, for example, plastic, bean-like material, sand, foam, memory foam or any combination thereof. Pads 24 may be supplied in a variety of pre-formed shape or a configuration wherein clinician or patient selects a pad 24 that best fits and supports patient's leg.

Pad 24 may be reusable or may be used one or more times before being removable and disposed. Reusable pad may be used for several treatments prior to disposal or may be designed to be used for the life of the apparatus 10. Disposable pad may be used for a single treatment or may be used for two or more treatments before being discarded.

In yet another embodiment of the present disclosure, pad 24 may be formed of a moldable material such as foam, memory foam, clay, plaster, paste, gel, etc. In FIG. 2, pad 24a′ is a rectangular block in an unmolded or relaxed state. As further illustrated in FIG. 2, the material of pad 24a′ conforms to the patient's leg when the leg is applied as shown by pad 24b′. Pads 24a′, 24b′ may maintain the shape after the leg is removed or pads 24a′, 24b′ may return to the unmolded or relaxed state.

With reference to FIG. 3, low profile vibrating plate assembly 100 includes a low profile base 102 and a platform 104. Platform 104 rests within a cavity 103 formed on a top surface of base 102. A first set of magnets 106a is positioned on an underside portion of platform 104. Moreover, a second set of magnets 106b is positioned on a lower surface of cavity 103 of base 102. In a preferred embodiment, first set of magnets 106a is positioned in direct relation to second set of magnets, as illustrated in FIG. 3. Preferably, each paired magnet 106a and 106b are set with equivalent polarities facing each other, thus providing a repellant force therebetween consequently causing platform 104 to levitate above base 102. Vibrating plate assembly 100 further includes a processor 108 in operable communication with the second set of magnets 106b. Preferably, the second set of magnets 106b includes adjustable magnetic properties (e.g., polarity, magnetic field intensity) controlled by a processor 108. First and second set of magnets 106a, 106b may include, for example, static magnetic field generating devices, such as, for example, permanent Ferro-magnets, electromagnets, and coils. Other dynamic magnetic field generating devices is also envisioned.

By varying the field intensity and/or alternating the polarity of the base magnets 106b a vertical vibration of platform 104 may be induced. The vibrational frequency is determined by the rate of change of the magnetic properties, while the amplitude of the vibration is determined by the magnetic field intensity. Additionally, the magnetic field intensity may be increased or decreased as needed, depending on a patient's weight, to properly condition and vibrate platform 104. In accordance with the present disclosure, a patient or user is permitted to stimulate and enhance blood flow in the limbs, in a manner described in detail hereinbelow.

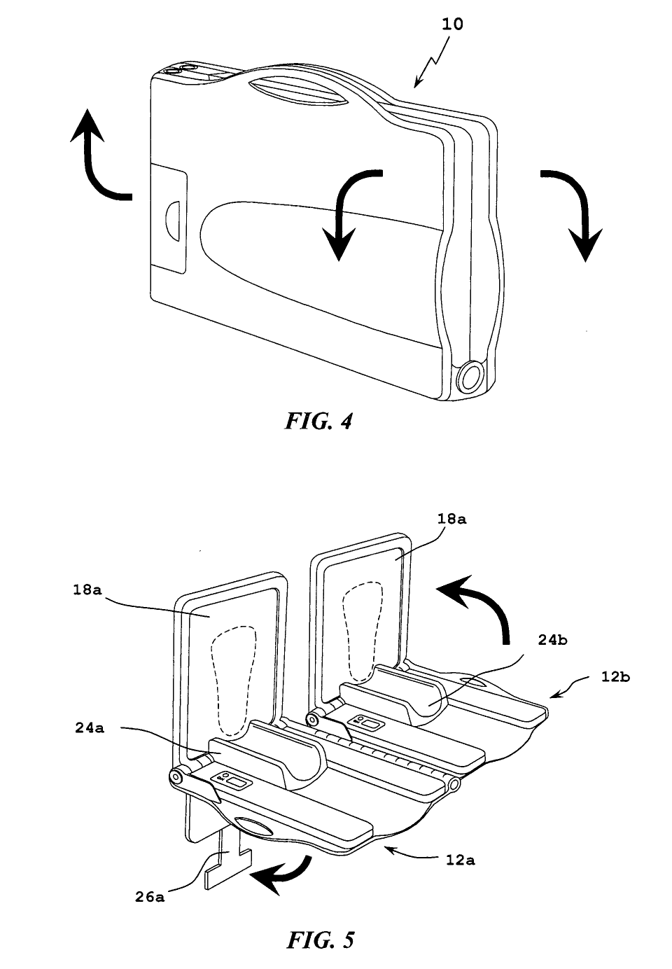

When used, assembly 10 is first switched from a portable configuration, as illustrated in FIGS. 1 and 4, to a configuration in which the two apparatuses 10a, 10b are in a closed configuration, as illustrated in FIG. 8. As discussed hereinbelow, assembly 10 may deliver vibrational therapy to a patient standing on apparatuses 10a, 10b in a closed configuration. Positioners 18a, 18b may be pivoted from a closed configuration to the open configuration, as illustrated in FIG. 5 by the large curved arrow, by pivoting each positioners 18a, 18b away from the respective platform member 12a, 12b. Locating member 26a (26b not shown) pivots from a first condition to a second position, as indicated by the small arrow.

As illustrated in FIG. 6, apparatuses 10a, 10b of assembly 10 may also be separated from each other, as indicated by the double arrow. Assembly 10 may be separated into two apparatuses 10a, 10b in either a closed configuration or an open configuration by removing the connecting pin (not shown). Apparatuses 10a, 10b while in a closed configuration may be used be used to deliver therapeutic vibrational energy in a closed configuration or positioners 18a, 18b may be lifted upward, as shown by the large arrow, to expose vibrating plate assembly 100a, 100b. Alternatively, positioners 18a, 18b may pivot to an open configuration, as indicated by the large arrow, prior to separating the apparatuses 10a, 10b, as indicated by the double arrow. Locating member 26a, 26b, for positioning apparatuses 10a, 10b on a structure, are deployable from a first condition to a second condition, as indicated by the small arrow.

As shown in FIG. 7, locating member 26a is used for positioning apparatus 10a, 10b on a structure, such as, for example, the edge of a mattress 300.

As illustrated in FIGS. 5-7, removable support pads 24a 24b are positioned on vibrating plate 100a, 100b prior to initiating vibrational treatment. It is envisioned that the assembly 10 may also be used without the support pads 24a, 24b.

As illustrated in FIGS. 6 and 7, apparatuses 10a, 10b may be detached, as shown by the double arrow in FIG. 6, for enabling treatment of one leg, if so desired, and for providing comfort to the patient. Each vibrating plate assembly 100a 100b has its own control panel 22a, 22b for enabling only one vibrating plate assembly 100a, 100b to be operated or actuated at a time, if so desired, for delivering vibrational energy.

FIG. 8 is a perspective view of the vibrational therapy assembly 10 including a first vibrational therapy apparatuses 10a and a second vibrational therapy apparatus 10b in a closed configuration. Positioners 18a, 18b are in juxtaposed relation to each respective platform member 12a, 12b. A human patient stands on assembly 12 with a foot positioned on each apparatus 10a, 10b. Proper foot placement may be indicated by a target, such as a footprint 19a, 19b or inset area (not shown) on positioner 18a, 18b. Pad 24a compresses due to the weight of the patient standing on positioner 18a, 18b, or pad 24a may be removed prior to positioning in a closed configuration. Positioners 18a, 18b contact at least a portion of platform members 12a, 12b, such that vibrational energy from vibrating plate assembly 100a, 100b is transferred to the respective positioner 18a, 18b. Handle 16b may be used to position or carry assembly 10.

In yet another embodiment of the present disclosure, positioner 18 includes at least one vibrational plate assembly, such as vibrating plate assembly 100, adapted to provide vibrational energy to patient tissue. In a closed configuration, vibrational plate assembly, of positioner, may deliver vibrational energy to patient tissue independent of the vibrational plate assembly 100 of platform member 12. For example, in the closed configuration, energy may be delivered from the vibrational plate assembly of positioner 18, and, in the open configuration, vibration energy may be delivered from the vibrational plate assembly 100 of platform member 12.

Alternatively, the first vibrational plate assembly 100 of platform member 12 and the vibrational plate assembly of positioner 18 may deliver vibrational energy simultaneously or may alternate delivery of vibrational energy.

The two or more vibrating plate assemblies may simultaneous deliver energy having the same frequency or may deliver vibrational energy having different frequencies.

Use of vibrational therapy assembly 10 is illustrated in FIG. 9. Footprints 19a, 19b on positioners 18a, 18b guide positioning of patient tissue P adjacent to or over at least a portion of platform member 12a, 12b, such as, for example, the positioning of a patient's foot P adjacent the vibrating plate assembly 100a, 100b. Vibrational energy, generated by each vibrating plate assembly 100a, 100b, is transferred through the respective positioner 18a, 18b to patient tissue P.

With reference to FIGS. 2, 7 and 9, vibrational therapy apparatus 10a, 10b and assembly 10 provide vibrational energy to patient tissue P with positioners 18a, 18b in various configurations. In FIGS. 2 and 7, positioners 18a, 18b are substantially perpendicular to platform member 12a, 12b. In FIG. 9, positioners 18a, 18b are in a juxtaposed relation to the platform member 12a, 12b and the various portions of the platform member 12a, 12b, such as, for example, the vibrating plate assembly 100a, 100b.

With reference to FIGS. 1, 2 and 8, after use, apparatus 10a, 10b is switched from an open configuration, as shown in FIG. 2, to a closed configuration, as shown in FIG. 8, where each positioner 18a, 18b is in juxtaposed relation to the respective platform members 12a, 12b. For ease of storage and for transporting assembly 110, apparatuses 10a, 10b in a closed configuration, as shown in FIG. 2, are folded together such that apparatuses 10a, 10b are in juxtaposed relation to each other forming a portable configuration, as shown in FIGS. 1 and 4.

In yet another embodiment of the present disclosure, positioner can act as a platform or base for the apparatus for enabling the vibrating plates 100 to be positioned vertically with respect to the positioner. In this configuration, a user is able to rest his legs within the removable pads 24 while seated.

With reference to FIG. 7, vibrational therapy apparatus 10a, 10b of the present disclosure are used to enhance blood flow in order to treat and prevent the onset of DVT. The amount of treatment time and the number of treatment sessions per day depends on whether the patient is treating DVT or is preventing the onset of DVT, the age of the patient, whether the patient is infirm, the weight of the patient (the heavier the patient, the longer the treatment time), etc.

It is envisioned to provide a processor, with memory capable of executing a set of instruction stored in the processor's memory, for enabling the apparatus 10a, 10b to be programmable via either by the user through the user interface on the control pad 22a, 22b or by a remote connection via communications circuitry provided within the apparatus 10a, 10b and in operative communication with the processor as described in a U.S. patent application filed on Jul. 17, 2006 titled “Dynamic Motion Therapy Apparatus Having a Treatment Feedback Indicator” , the entire contents of which are incorporated herein by reference. The processor can be programmed to sound an alarm when a treatment session should be started and to automatically shut-off the vibrating plate assembly 100a, 100b when the treatment time has lapsed. A memory within the processor can store patient treatment-related data and other information, such as name of patient, age, prescription medications being taken by patient, etc. The treatment related data can be transmitted to a remote monitoring station as described in a U.S. patent application filed on Jul. 17, 2006 titled “Dynamic Motion Therapy Apparatus Having a Treatment Feedback Indicator”,

While several embodiments of the disclosure have been shown in the drawings and/or discussed herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. A vibrational therapy apparatus comprising:
at least one platform member including at least one low profile vibrating plate assembly for providing vibrational energy; and
at least one positioner pivotably coupled to said at least one platform member for guiding patient tissue adjacent said at least one low profile vibrating plate assembly.

2. The apparatus according to claim 1, wherein said at least one low profile vibrating plate assembly provides vibrational energy in at least two configurations of said at least one positioner.

3. The apparatus according to claim 2, wherein in a first configuration of said at least two configurations said at least one positioner is substantially perpendicular to said at least one platform member.

4. The apparatus according to claim 2, wherein in a second configuration of said at least two configurations said at least one positioner is in juxtaposed relation to said at least one platform member.

5. The apparatus according to claim 1, wherein said at least one positioner is moveable between a first position and a second position.

6. The apparatus according to claim 2, wherein in a first configuration of said at least two configurations said patient tissue contacts said at least one low profile vibrating plate assembly, and in a second configuration of said at least two configurations said patient tissue does not contact said at least one low profile vibrating plate assembly.

7. The apparatus according to claim 1, wherein said apparatus is adapted for treating Deep Venous Thrombosis.

8. The apparatus according to claim 3, further comprising at least one locating member operatively associated with one of said at least one platform member and said at least one positioner.

9. The apparatus according to claim 1, wherein said at least one positioner includes at least one low profile vibrating plate assembly.

10. The apparatus according to claim 3, further comprising at least one pad positioned on said at least one platform member, said at least one pad configured to contact said patient tissue.

11. The apparatus according to claim 10, wherein said at least one pad is formed of memory foam material.

12. The apparatus according to claim 10, wherein said pad contacts at least a portion of said at least one positioner.

13. The apparatus according to claim 10, wherein said pad is removable and disposable.

14. The apparatus according to claim 1, further comprising a control panel for controlling the operation of said at least one low profile vibrating plate assembly.

15. The apparatus according to claim 1, wherein said at least one platform member defines a handle.

16. A vibrational therapy assembly comprising:
a first vibrational therapy apparatus comprising:
a first platform member including at least one vibrating plate assembly for providing vibrational energy; and
a first positioner pivotably coupled to said first platform member for guiding patient tissue adjacent said at least one vibrating plate assembly; a second vibrational therapy apparatus comprising:
a second platform member including at least one vibrating plate assembly for providing vibrational energy;
a second positioner pivotably coupled to said second platform member for guiding patient tissue adjacent said at least one vibrating plate assembly; and
means for removably connecting said first and second vibrational therapy apparatus.

17. The assembly according to claim 16, wherein said means for removably connecting engages and disengages said first vibrational therapy apparatus from said second vibrational therapy apparatus.

18. The assembly according to claim 16, wherein said first vibrational therapy apparatus and said second vibrational therapy apparatus are actuating for providing vibrational energy in at least two positioners.

19. The assembly according to claim 18, wherein in a first configuration of said at least two configurations said first and second platform members are substantially parallel with respect to each other and said first and second positioners are substantially perpendicular to respective said first and second platform members.

20. The assembly according to claim 18, wherein in a second configuration of said at least two configurations said first and second platform members are substantially parallel with respect to each other and said first and said second positioners are respectively in juxtaposed relation to said first and said second platform members.

21. The assembly according to claim 16, further comprising:
a first locating member operatively associated with said first vibrational therapy apparatus; and
a second locating member operatively associated with said second vibrational therapy apparatus.

22. The assembly according to claim 16, wherein said first and second positioners are in juxtaposed relation to said first and second platform members, and wherein said first vibrational therapy apparatus is in juxtaposed relation to said second vibrational therapy apparatus.

23. The assembly according to claim 22, wherein said first and second platform members define at least one handle.

24. A method for providing vibrational therapy, said method comprising:
providing a platform member having a low profile vibrating plate assembly;
guiding patient tissue over said low profile vibrating plate assembly using a positioner pivotably coupled to said platform member; and
actuating said low profile vibrating plate assembly.

25. The method according to claim 24, further comprising the step of adjusting said positioner relative to said platform member.

26. The method according to claim 25, wherein the step of guiding patient tissue includes the step of having the patient stand on said positioner.

27. The method according to claim 25, wherein the step of guiding patient tissue includes the step of placing at least a portion of a patient's leg onto said platform member.

28. The method according to claim 24, further comprising the step of providing a pad on said at least one platform member.

29. The method according to claim 24, further comprising the step of transmitting treatment-related data to a remote monitoring station.
